(19) United States
(12) Patent Application Publication
(10) Pub. No.: US 2015/0169144 A1
(43) Pub. Date: Jun. 18, 2015

(54) Presenting Response Options to Questions

(71) Applicant: Joshua Abraham Tabak, Seattle, WA (US)

(72) Inventor: Joshua Abraham Tabak, Seattle, WA (US)

(73) Assignee: GOOGLE INC., Mountain View, CA (US)

(21) Appl. No.: 13/295,951

(22) Filed: Nov. 14, 2011

(51) Int. Cl. G06F 3/0482; G06F 3/0484

(52) U.S. Cl. CPC G06F 3/0482; G06F 3/04842

(57) ABSTRACT

A method for presenting survey questions and response options to survey respondents includes determining response option locations on the GUI for display of two or more graphical objects, each graphical object including at least a selectable response option for the closed-ended question, where the two or more graphical objects are centered along more than one vertical axis or horizontal axis. The method includes identifying two or more graphical objects each including at least a selectable response option to the closed-ended question. The method also includes retrieving the two or more identified graphical objects, and randomly populating the response option locations with the retrieved two or more graphical objects.

### BACKGROUND

The present disclosure relates to presenting response options to questions, e.g., closed-ended questions.

Presenting survey respondents with response options to closed-ended questions in surveys can include displaying response options together in a single line and ranked in ascending or descending order. Respondents to multiple questions that have similar sets of response options (e.g., multiple questions that all have similar or identical 5-point or 7-point response options), tend to respond similarly to the multiple items without properly considering all questions and all possible responses to identify the best response. Respondents tend to select responses that are improperly similar, as compared to what would be expected based on latent values. These improperly similar responses are induced in large part because the perceptual arrangement of response options is highly similar across questions. The technical term for this problem is “method variance” (i.e., a certain amount of the variance in responses is caused by the method of asking the questions, which includes the presentation of response options). The existing method of presenting response options together in a single line and ranked in ascending or descending order also induces satisficing behavior (i.e., selecting the first available response which seems appropriate, even if not the best available response option), and behavior based on personal and/or cultural response tendencies.

### SUMMARY

In one aspect, a method includes determining response option locations for displaying two or more graphical objects, each graphical object including at least a selectable response option to a question, where the two or more graphical objects are axially aligned on more than one vertical axis or horizontal axis. The method also includes identifying two or more graphical objects each including at least a selectable response option to the closed-ended question. The method includes retrieving from the database of selectable response options the two or more identified graphical objects, and the method includes randomly populating the response option locations with the retrieved two or more graphical objects. These and other embodiments can include corresponding systems, apparatus, including computer program products.

These and other embodiments can include one or more of the following features. In some embodiments, the display of two or more graphical objects forms a geometric shape. In some embodiments, the geometric shape varies between each sequential questions, and in some embodiments, the outside boundary of the geometric shape is one of a square, rectangle, triangle, star, pound symbol, rhombus, diamond, or trapezoid. In some embodiments, the method includes randomly selecting a geometric shape from an allowed set of geometries.

In some embodiments, the display of two or more graphical objects is a random placement of selectable response options in text format without any boundary shape around each textual response option. In some embodiments, the method includes creating a printable form of one or more survey questions and response options.

In some embodiments, the method includes presenting the question for display. In some embodiments, the question is closed-ended.

In another aspect, a system includes a display module configured to display, via a display device, a graphical user interface (GUI) with one or more sets of graphical objects, each graphical object corresponding to a selectable response option for a question. The system includes a graphical object selection module configured to identify and retrieve two or more graphical objects each including at least a selectable response option to the question. The system includes a patterning module configured to randomly populate the GUI with a response option pattern including the retrieved two or more graphical objects, where the two or more graphical objects are centered along more than one vertical axis or horizontal axis. These and other embodiments can include corresponding methods, apparatus, including computer program products.

These and other embodiments can include one or more of the following features. In some embodiments, the response survey generation system includes a selection module for selecting different response option patterns between sequential displays of questions. In some embodiments, the selection module retrieves response option patterns from a list of available patterns. In some embodiments, the list of available response option patterns includes geometric shapes. In some embodiments, the outside boundary of each of the geometrical shapes is one of a square, rectangle, triangle, star, pound symbol, rhombus, diamond, or trapezoid. In some embodiments, the selection module randomly selects a geometric shape from the list of available response option patterns. In some embodiments, the response option pattern of the retrieved two or more graphical objects is a random placement of selectable response options in text format without any boundary shape around each textual response option.

In some embodiments, the system includes one or more additional display modules in communication with the graphical object selection module and the patterning module. In some embodiments, the graphical object selection module selects a single graphical object and associated response object for display on each one of the display modules.

In some embodiments, the display module is configured to display the question. In some embodiments, the question is closed-ended.

The disclosure, in another aspect, features a computer program product tangibly embodied on computer-readable media. The computer program product includes instructions that are operable to cause a data processing apparatus to determine response option locations on a graphical user interface (GUI) for two or more graphical objects, each graphical object including at least a selectable response option for a question, where subsets of the two or more graphical objects are centered along more than one vertical axis or horizontal axis. The instructions are operable to cause the data processing apparatus to identify two or more graphical objects each including at least a selectable response option to the question. The instructions are operable to cause the data processing apparatus to retrieve the two or more identified graphical objects. The instructions are operable to cause the data processing apparatus to randomly populate the response option locations with the retrieved two or more graphical objects. These and other embodiments can include corresponding methods, apparatus, and systems.

These and other embodiments can include one or more of the following features. In some embodiments, the computer program product is configured to display the question on the graphical user interface (GUI). In some embodiments, the question is closed-ended.

In one aspect, a method includes determining response option locations for displaying two or more graphical objects, each graphical object including at least a selectable response option to a question, where the two or more graphical objects are axially aligned on more than one vertical axis or horizontal axis. The method also includes identifying two or more graphical objects each including at least a selectable response option to the closed-ended question. The method includes retrieving from the two or more identified graphical objects, and the method includes populating the response option locations with the retrieved two or more graphical objects. These and other embodiments can include corresponding systems, apparatus, including computer program products.

These and other embodiments can include one or more of the following features. In some embodiments, the display of two or more graphical objects forms a geometric shape. In some embodiments, the geometric shape varies between each sequential questions, and in some embodiments, the outside boundary of the geometric shape is one of a square, rectangle, triangle, star, pound symbol, rhombus, diamond, or trapezoid. In some embodiments, the method includes randomly selecting a geometric shape from an allowed set of geometries.

In some embodiments, the display of two or more graphical objects is a random placement of selectable response options in text format without any boundary shape around each textual response option. In some embodiments, the method includes creating a printable form of one or more survey questions and response options.

In some embodiments, populating the response option locations with the retrieved two or more graphical objects occurs randomly. In some embodiments, the method includes displaying the question. In some embodiments, the question is closed-ended.

These and other embodiments may provide one or more of the following advantages. By randomly varying the geometric shape used for successive displays of response options to sequential questions and/or randomly varying the display order of the two or more response options, the embodiments may reduce the likelihood of respondents selecting the same response, presented in the same location on the GUI in response to each question. The embodiments thereby reduce the likelihood of satisficing behavior and/or personal tendencies for responding to survey questions. Accordingly, the embodiments reduce the likelihood that satisficing would bias the average response to a particular question by forcing respondents to look for and identify the most accurate response to every question.

Other aspects and advantages of the current disclosure will become apparent from the following detailed description, taken in conjunction with the accompanying drawings, illustrating the principles of the disclosure by way of example only.

### BRIEF DESCRIPTION OF THE DRAWINGS

The foregoing features of various embodiments of the disclosure will be more readily understood by reference to the following detailed descriptions in the accompanying drawings, in which:

FIG. 1 is a schematic illustration of an example presentation of response options to close-ended questions.

FIG. 2 is a flowchart of a method for presenting response options to questions, according to an illustrative embodiment.

FIG. 3A is a schematic illustration of a presentation of response options to questions, according to an illustrative embodiment.

FIG. 3B is a schematic illustration of a presentation of response options to close-ended questions, according to an illustrative embodiment.

FIG. 3C is a schematic illustration of a presentation of response options to close-ended questions, according to an illustrative embodiment.

FIG. 3D is a schematic illustration of a presentation of response options to close-ended questions, according to an illustrative embodiment.

FIG. 3E is a schematic illustration of a presentation of response options to close-ended questions, according to an illustrative embodiment.

FIG. 4 is a schematic illustration of a system for presenting response options to close-ended questions, according to an illustrative embodiment.

FIG. 5 is a flowchart of a method for presenting response options to close-ended questions, according to an illustrative embodiment.

### DETAILED DESCRIPTION

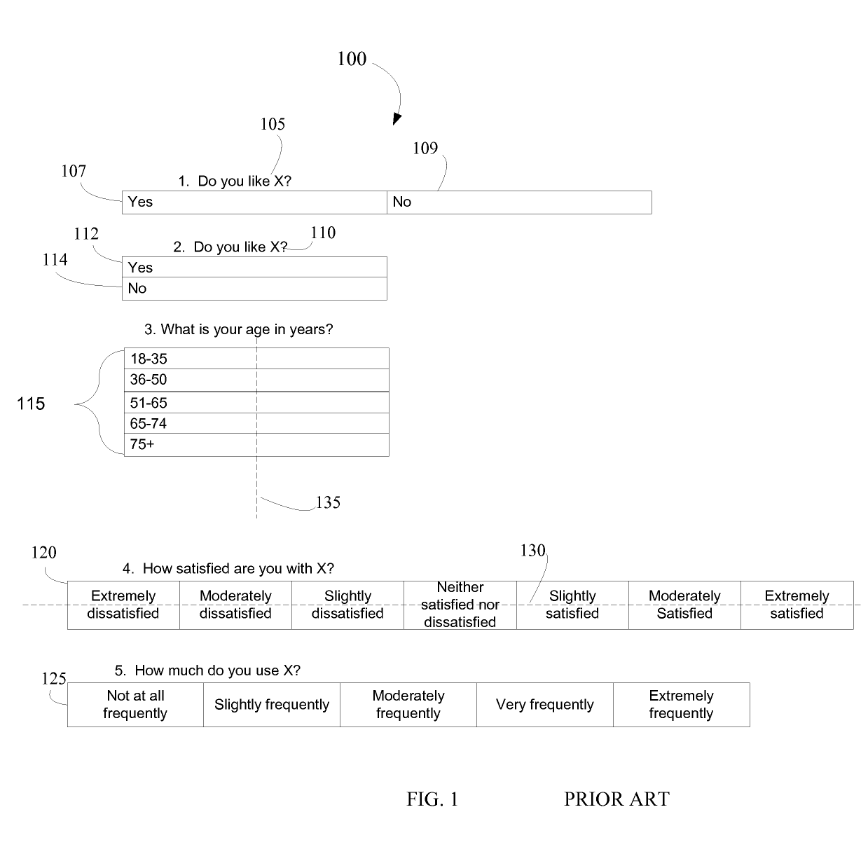

FIG. 1 is a schematic illustration 100 of example presentations of response options to closed-ended questions. Closed ended questions are questions having two or more specific, defined response options, such as, for example “Do you like X?” 105, 110. In response, a respondent will choose “Yes” 107, 112 or “No” 109, 114. Such closed ended questions are frequently employed in surveys, such as those, for example, produced by a person or institution conducting product research, marketing research, user preference research, consumer preference research, political research, social science research, biomedical research, or any other type of research relying on responses submitted by human participants (e.g., respondents).

Closed ended inquiries include displaying response options together in a single line and ranked in ascending or descending order, such as a list of increasing ranges 115. Respondents to multiple questions that have similar sets of response options (e.g., multiple questions that all have similar or identical graduated subjective response options across 7-point 120 or 5-point 125 scales) may respond improperly similarly to the multiple questions and more similarly than would be expected based on what are actually determined to be true response values. These improperly similar responses are induced in large part because the perceptual arrangement of response options is highly similar across questions. The technical term for this problem is “method variance.” (i.e., A certain amount of the variance in responses is caused by the method of asking the questions, which includes the presentation of response options.)

Presenting response options to questions (e.g., closed-ended questions or closed-ended evaluation statements) in a non-ascending or descending configuration will reduce method variance, satisficing behavior, and personal response tendencies common to self-report responses to closed-ended questions. Satisficing behavior involves a survey respondent selecting the first available response that seems appropriate, even if it's not the best available response option. Personal and/or cultural response tendencies include, for example, frequently selecting endpoints of response options, or never selecting endpoints of response options.

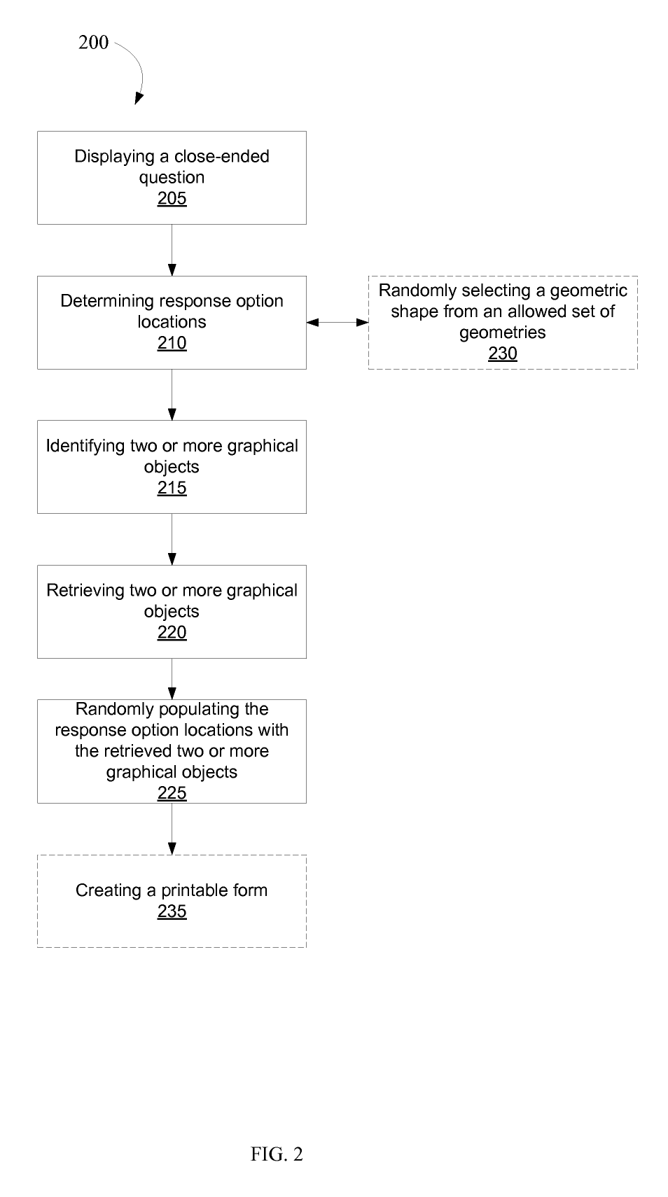

FIG. 2 is a flowchart 200 of an embodiment of a method for presenting survey response options to survey respondents. In one embodiment, the method includes presenting a survey question for display. In one embodiment, the method presents response options for each question in a row, but the ranking of responses is in a random, non-consecutive order. In another embodiment, the method of presentation reduces method variance and satisficing behavior by presenting response options in an arrangement that is random and unpredictable from the viewpoint of a respondent. By presenting response options in an unpredictable manner that varies between subsequent questions, the method ensures that respondents will be less likely to respond improperly similarly to different questions. The method requires that a respondent deliberately find the desired response option rather than merely selecting a seemingly convenient response option (e.g. a response option previously selected in the same field in a similarly or identically displayed list of responses).

In one embodiment, the method optionally includes displaying 205 a question, e.g., a close-ended question, on a graphical user interface (GUI). The method includes determining 210 response option locations on the GUI for display of two or more graphical objects, each graphical object including at least a selectable response option for the question, where the two or more graphical objects are axially aligned on more than one single vertical axis or horizontal axis. The method also includes identifying 215 within two or more graphical objects each including at least a selectable response option to the question. In one embodiment, for example, the two or more graphical objects may be stored within a database of selectable response options. The method includes retrieving 220 the two or more identified graphical objects (e.g., from a database of selectable response options) and the method includes populating 225 the response option locations with the retrieved two or more graphical objects. In one embodiment, populating 225 the response option locations occurs randomly. In other words, the two or more graphical objects appear as if they have been placed in no particularly ordered arrangement, but rather appear randomly placed spatially on the display.

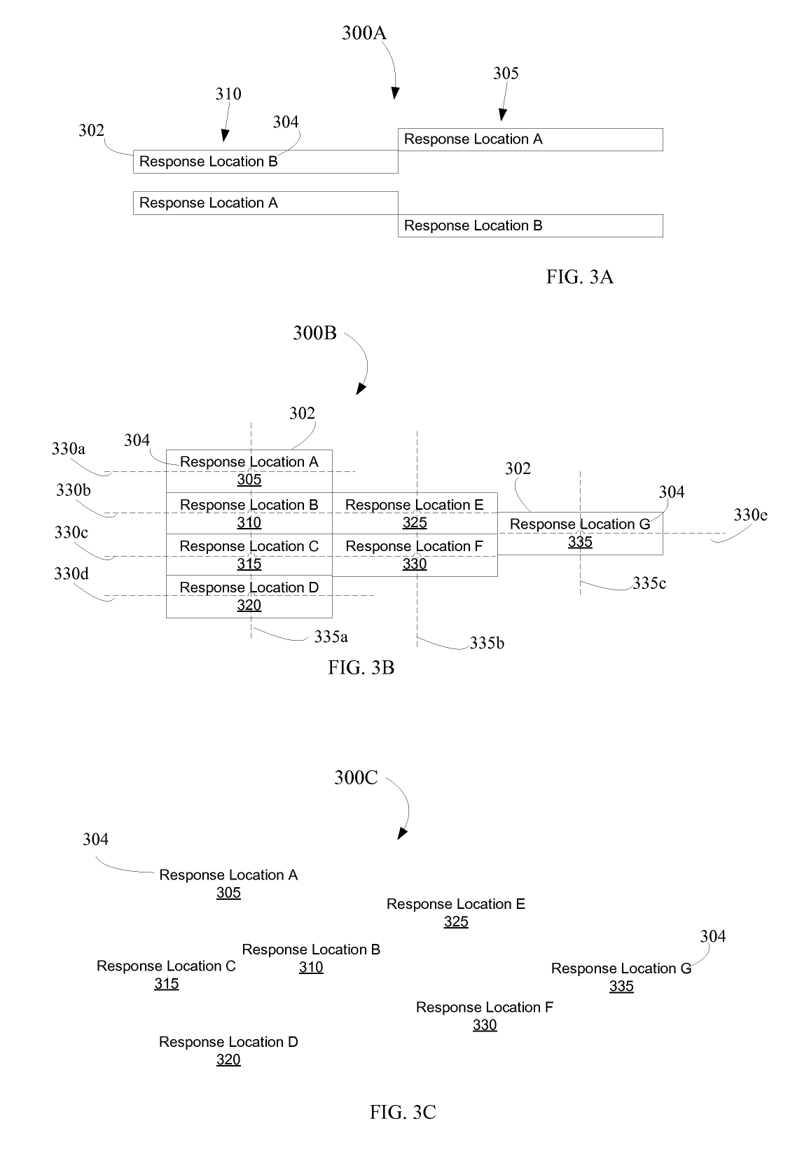

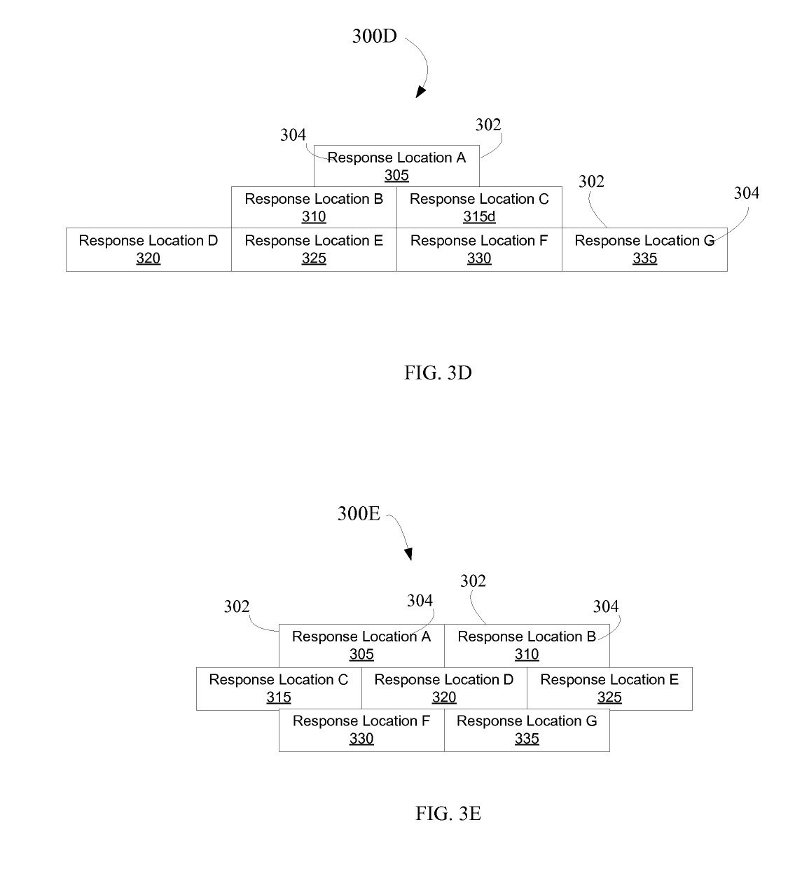

In some embodiments, the display of two or more graphical objects collectively forms a geometric shape (e.g., the outside boundary defined in each of FIGS. 3A, 3B, 3D and 3E). In some embodiments, the geometric shape varies between displays of sequential questions, and in some embodiments, the outside boundary of the geometric shape is one of a square, rectangle, triangle, star, pound symbol, rhombus, diamond, or trapezoid. In some embodiments, the method includes randomly selecting 230 a geometric shape from an allowed set of geometries. By randomly varying successive geometric shapes used for presenting response options to sequential questions and/or randomly varying the display order of the two or more response options, the method may reduce the likelihood of respondents selecting the same response, presented in the same location on the GUI in response to each question. The method thereby reduces the likelihood of satisficing behavior and/or personal tendencies for responding to survey questions. Accordingly, the method reduces the likelihood that satisficing would bias the average response to a particular question by forcing respondents to look for and identify the most accurate response to every question.

In some embodiments, the display of two or more graphical objects is a random placement of selectable response options in text format, without any boundary shape around each textual response option, as shown, for example, in FIG. 3C. In some embodiments, the method includes creating 235 a printable form of one or more survey questions and response options.

For example, as shown in the embodiments of FIGS. 3A, 3B, 3D and 3E, each graphical object 305, 310, 315, 320, 325, 330, and 335, is a tile including a boundary line 302 surrounding a selectable textual response option 304. Although the embodiments of FIGS. 3A, 3B, 3D and 3E depict boundary lines 302 each in the shape of a rectangle, in some embodiments, the boundary line shapes or combinations of boundary line shapes are, for example but not limited to, one or more of the following: ellipses, circles, squares, triangles, diamonds, and trapezoids. Although the embodiments of FIGS. 3A through 3E depict selectable textual response options 304, in some embodiments, the selectable response options are drawings or images presented alone or in combination with text and/or numerical scale values. Each graphical object 305, 310, 315, 320, 325, 330, and 335 is arranged such that the perceptible overall appearance of the collective geometric shape 300A, 300B, 300C, 300D, 300E of the two or more graphical objects 305, 310, 315, 320, 325, 330, and 335 is neither a purely horizontal row nor a purely vertical column. By randomly patterning the graphical objects 305, 310, 315, 320, 325, 330, and 335, the method of presenting survey questions and response options precludes repeatedly presenting response options in the same locations on the GUI for responding to subsequent questions. The method therefore reduces, and in some instances precludes, respondent bias by forcing respondents to search the response options for a best, most accurate value.

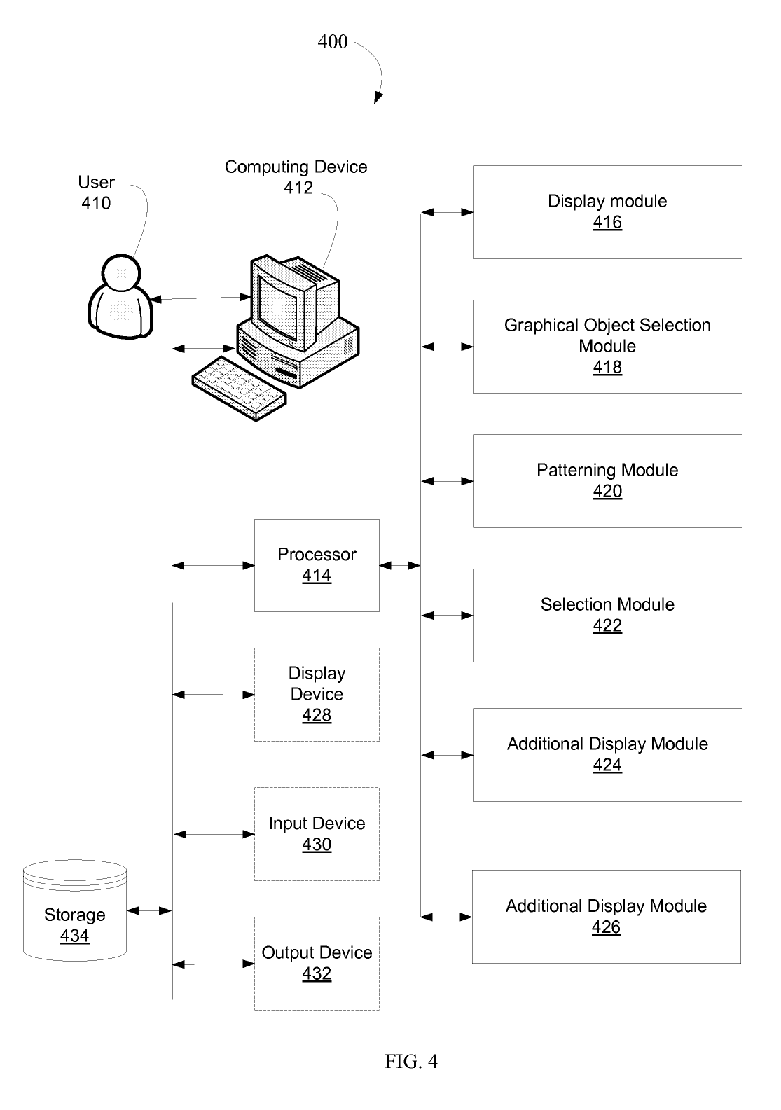

In some embodiments, the method produces a hard copy survey and in other embodiments, the method produces an electronic survey display. FIG. 4 is a schematic illustration of an interactive response survey generation system 400 (hereinafter “system”) for electronically presenting response options to questions, according to an illustrative embodiment. The system 400 includes a computing device 412 that includes a processor 414. The processor 414 includes a plurality of modules 416, 418, 420, 422, 424, and 426. The processor 414 communicates with each of the modules to implement the methods described herein (e.g., the method of FIG. 2). In this embodiment, a user 410 interacts with computing device 412, and the user 410 is a respondent to survey questions.

To enable interaction with the respondent, the system 400 further includes a display device 428, an input device 430, an output device 432, and a storage device 434. The input device 430, the output device 432, and the display device 428 are optional components of the system 400. The modules and devices described herein can, for example, utilize the processor 414 to execute computer executable instructions and/or the modules and devices described herein can, for example, include their own processor to execute computer executable instructions (e.g., an encryption processing unit, a field programmable gate array processing unit, etc.). It should be understood that the system 400 can include, for example, other modules, devices, and/or processors and/or varieties of the illustrated modules, devices, and/or processors.

The input device 430 receives information associated with the system 400 from a user 410 and/or another computing system (not shown). The input device 430 can include, for example, a keyboard, a scanner, etc. The output device 432 outputs information associated with the system 400 (e.g., information to a printer (not shown), information to a speaker, etc.).

The display device 428 displays information associated with the system 400 (e.g., status information, configuration information, graphical objects, etc.). The processor 414 executes the operating system and/or any other computer executable instructions for the system 400 (e.g., executes applications, etc.).

The storage device 434 stores graphical object information and/or response options. The storage device 434 can include a plurality of storage devices and/or the system 400 can include a plurality of storage devices. The storage device 434 can include, for example, long-term storage (e.g., a hard drive, a tape storage device, flash memory, etc.), short-term storage (e.g., a random access memory, a graphics memory, etc.), and/or any other type of computer readable storage.

In the embodiment of FIG. 4, the computing device 412 includes a display module 416 that is configured to display a graphical user interface (GUI) with a question, e.g. a closed-ended question, and one or more sets of graphical objects, each graphical object corresponding to a selectable response option for the question. In some embodiments, the display module 416 optionally displays the question.

The system includes a graphical object selection module 418 configured to identify and retrieve two or more graphical objects each including at least a selectable response option to the question. In one embodiment, for example, the two or more graphical objects may be stored within the one or more storage devices 434. The system includes a patterning module 420 configured to populate the GUI with a response option pattern including the retrieved two or more graphical objects, where the two or more graphical objects are axially aligned on more than one vertical axis or horizontal axis. In some embodiments, populating the GUI occurs randomly. This is illustrated, for example, in the embodiments of FIGS. 3A through 3E, in which the two or more graphical objects are axially aligned on more than one perceptibly-horizontal row or perceptibly-vertical column. In particular, the illustrative embodiment of FIG. 3B depicts three distinct vertical axes 335a, 335b, and 335c around which one or more graphical objects 305, 310, 315, 320, 325, 330, and 335 are centered. Subsets of one or more of the two ore more graphical objects are axially aligned with the three distinct vertical axes 335a, 335b, and 335c around which one or more graphical objects 305, 310, 315, 320, 325, 330, and 335. The embodiment of FIG. 3B also depicts five distinct horizontal axes 330a, 330b, 330c, 330d, and 330e around which one or more graphical objects 305, 310, 315, 320, 325, 330, and 335, but not all graphical objects, are centered.

In some embodiments, the system 400 includes a selection module 422 for selecting different response option patterns between sequential displays of questions, e.g. closed ended questions. In some embodiments, the selection module 422 retrieves response option patterns from a list of available patterns. In some embodiments, the list of available response option patterns (e.g., 300A through 300E) includes an allowed set of geometric shapes, and in some embodiments, the selection module 422 selects from the allowed set of geometric shapes according to one or more rules. A rule, for example, might be selecting one particular shape for displaying response options to even numbered questions in a survey and selecting a second shape for displaying response options to odd numbered questions in a survey. In some embodiments, the selection module 422 randomly selects a geometric shape from the list of available response option patterns. In some embodiments, the outside boundary of each of the geometrical shapes is one of a square, rectangle, triangle, star, pound symbol, rhombus, diamond, or trapezoid. In some embodiments, the response option pattern of the retrieved two or more graphical objects is a random placement of selectable response options in text format. In other embodiments, the response option pattern of the retrieved two or more graphical objects is a random placement of selectable response options in text and boundary tile format. In some embodiments, the system 400 randomly selects a response option shape for the two or more geometrical objects and also randomly populates available response options within each selectable graphical object of the response option shape thereby adding to the variability in display and random ordering of response options. This further prevents predictability in the display of response options and further reduces method variance, satisfying behavior and personal tendencies that otherwise would alter the statistical accuracy of solicited survey responses.

In some optional embodiments, the system includes one or more additional display modules 424, 426 in communication with the graphical object selection module 418 and the patterning module 420. In some embodiments, the graphical object selection module 418 selects a single graphical object and associated response object for display on each one of the display modules 416,424, 426. For example, the display modules 416, 424, 426 may be a plurality of devices, e.g., personal media players, where each display module has a GUI for displaying a single response option. The plurality of devices may be arranged in any order manually or by computerized means for mechanically driving physical placement of the plurality of display devices. As with the geometries of FIGS. 3A and 3E, the plurality display devices are capable of arrangement in a geometry that is not a purely perceptibly horizontal row or vertical column, thereby adding variability to response locations and requiring meaningful from a respondent searching for a best, or most appropriate question.

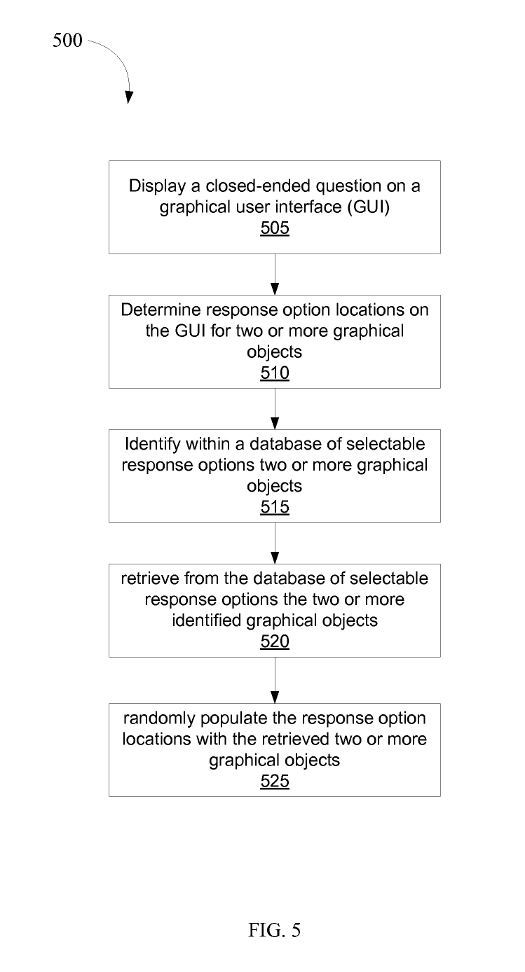

The disclosure, in another aspect, features a computer program product tangibly embodied on computer-readable media. As depicted in the illustrative embodiment of FIG. 5, the computer program product includes a set of instructions 500 that is operable to cause a data processing apparatus (e.g. the computer system 412 of FIG. 4) to display 505 a question (e.g., a closed-ended question) on a graphical user interface (GUI). In some embodiments, displaying 505 the question is optional. The instructions are operable to cause the data processing apparatus to determine response option locations 510 on the GUI for two or more graphical objects, each graphical object including at least a selectable response option for the question, where subsets of the two or more graphical objects are centered along more than one vertical axis or horizontal axis, or even more than one perceptually vertical axis or perceptually horizontal axis. A subset can be one or more of the two or more graphical objects. The instructions are operable to cause the data processing apparatus to identify 515 two or more graphical objects each including at least a selectable response option to the closed-ended question. The instructions are operable to cause the data processing apparatus to retrieve 520 the two or more identified graphical objects. In one embodiment, for example, the two or more graphical objects may be stored within a database of selectable response options. The instructions are operable to cause the data processing apparatus to randomly populate 525 the response option locations with the retrieved two or more graphical objects. In other words, the two or more graphical objects appear as if they have been placed in no particularly ordered arrangement, but rather appear randomly placed spatially on the display. In other embodiments, the instructions may cause the apparatus to populate the response option locations in a more particular order that is non-random or only partially random in appearance.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the disclosure by operating on input data and generating output. Method steps can also be performed by, and an apparatus can be implemented as, special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any sensory form (e.g., visual feedback, auditory feedback, or tactile feedback). Input from the user can, for example, be received in any form, including acoustic, speech, eye-gaze, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The computing device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser. The mobile computing device includes, for example, a smart phone.

Comprise, include, and/or plural forms of each are open ended and include the listed parts and can include additional parts that are not listed. And/or is open ended and includes one or more of the listed parts and combinations of the listed parts.

The disclosure may be embodied in other specific forms without departing from the spirit or essential characteristics thereof. The foregoing embodiments are therefore to be considered in all respects illustrative rather than limiting of the disclosure described herein. Scope of the disclosure is thus indicated by the appended claims, rather than by the foregoing description, and all changes that come within the meaning and range of equivalency of the claims are therefore intended to be embraced therein.

1. A method comprising:
determining a question to display in a graphical user interface;
determining response option locations in the graphical user interface for displaying two or more graphical objects according to a response option pattern selected from a group of response option patterns, each graphical object including at least a selectable response option for the question, wherein the two or more graphical objects are axially aligned on more than one vertical axis or horizontal axis according to the arrangement of the corresponding response option locations;
identifying the two or more graphical objects each including at least a selectable response option to the question;
retrieving the two or more identified graphical objects; and
randomly populating the response option locations with the retrieved two or more graphical objects in a display order for display in the graphical user interface.

2. The method of claim 1, wherein the display of two or more graphical objects according to the selected response option pattern forms a geometric shape.

3. The method of claim 2, wherein the geometric shape varies between each sequential question.

4. The method of claim 3, wherein the outside boundary of the geometric shape is one of a square, rectangle, triangle, star, pound symbol, rhombus, diamond, or trapezoid.

5. The method of claim 3, further comprising randomly selecting a geometric shape from an allowed set of geometries.

6. The method of claim 1, wherein the display of two or more graphical objects is a random placement of selectable response options in text format, without any boundary shape around each textual response option.

7. The method of claim 1, further comprising creating a printable form of one or more survey questions and response options.

8. The method of claim 1, further comprising presenting the question for display.

9. The method of claim 1, wherein the question is closed-ended.

10. A response survey generation system, the system comprising:
a display module configured to display, using a display device, a graphical user interface (GUI) with one or more sets of graphical objects, each graphical object corresponding to a selectable response option for a question;
a graphical object selection module configured to identify and retrieve two or more graphical objects each including at least a selectable response option to the question; and
a patterning module configured to randomly populate the GUI with a response option pattern selected from a group of response option patterns including the retrieved two or more graphical objects, wherein the two or more graphical objects are centered along more than one vertical axis or horizontal axis according to a corresponding arrangement of response option locations.

11. The response survey generation system of claim 10, further comprising a selection module for selecting different response option patterns between sequential questions.

12. The response survey generation system of claim 11, wherein the selection module retrieves response option patterns from a list of available patterns.

13. The response survey generation system of claim 12, wherein the list of available response option patterns includes geometric shapes.

14. The response survey generation system of claim 13, wherein the outside boundary of each of the geometric shapes is one of a square, rectangle, triangle, star, pound symbol, rhombus, diamond, or trapezoid.

15. The response survey generation system of claim 13, wherein the selection module randomly selects a geometric shape from the list of available response option patterns.

16. The response survey generation system of claim 10, wherein the response option pattern of the retrieved two or more graphical objects is a random placement of selectable response options in text format, without any boundary shape around each textual response option.

17. The response survey generation system of claim 10, further comprising one or more additional display modules in communication with the graphical object selection module and the patterning module.

18. The response survey generation system of claim 17, wherein the graphical object selection module selects a single graphical object and associated response object for display on each one of the display modules.

19. The response survey generation system of claim 10, wherein the display module configured to display the question.

20. The response survey generation system of claim 10, wherein the question is closed-ended.

21. A computer program product, tangibly embodied on non-transitory computer-readable media, the computer program product being configured to cause a data processing apparatus to:
determining a question to display in a graphical user interface;
determine response option locations on the graphical user interface for displaying two or more graphical objects according to a response option pattern selected from a group of response option patterns, each graphical object including at least a selectable response option for the question, wherein subsets of the two or more graphical objects are centered along more than one vertical axis or horizontal axis according to the arrangement of the corresponding response option locations;
identify the two or more graphical objects each including at least a selectable response option to the question;
retrieve the two or more identified graphical objects; and
randomly populate the response option locations with the retrieved two or more graphical objects in a display order for display in the graphical user interface.

22. The computer program product of claim 21, wherein the computer program product is further configured to display the question on the graphical user interface.

23. The computer program product of claim 22 wherein, the question is closed-ended.

24. A method comprising:
determining a question to display in a graphical user interface;
determining response option locations in the graphical user interface for displaying two or more graphical objects according to a response option pattern selected from a group of response option patterns, each graphical object including at least a selectable response option for the question, wherein the two or more graphical objects are axially aligned on more than one vertical axis or horizontal axis according to the arrangement of the corresponding response option locations;
identifying the two or more graphical objects each including at least a selectable response option to the question;
retrieving the two or more identified graphical objects; and
populating the response option locations with the retrieved two or more graphical objects in a display order for display in the graphical user interface.

25. The method of claim 24, wherein the display of two or more graphical objects according to the selected response option pattern forms a geometric shape.

26. The method of claim 24, wherein the geometric shape varies between sequential questions.

27. The method of claim 26, wherein the outside boundary of the geometric shape is one of a square, rectangle, triangle, star, pound symbol, rhombus, diamond, or trapezoid.

28. The method of claim 26, further comprising randomly selecting a geometric shape from an allowed set of geometries.

29. The method of claim 24, wherein the display of two or more graphical objects is a random placement of selectable response options in text format, without any boundary shape around each textual response option.

30. The method of claim 24, further comprising creating a printable form of one or more survey questions and response options.

31. The method of claim 24, wherein populating the response option locations with the retrieved two or more graphical objects occurs randomly.

32. The method of claim 24, wherein the question is closed-ended.

33. The method of claim 24, further comprising displaying the question.
